(19) United States
(12) Patent Application Publication
(10) Pub. No.: US 2026/0057809 A1
(43) Pub. Date: Feb. 26, 2026

(54) Marking Label

(71) Applicant: HellermannTyton Corporation, Milwaukee, WI (US)

(72) Inventors: Todd Fries, Waukesha, WI (US); Jonathan Zick, Waukesha, WI (US)

(73) Assignee: HellermannTyton Corporation, Milwaukee, WI (US)

(21) Appl. No.: 19/250,511

(22) Filed: Jun. 26, 2025

Related U.S. Application Data
(60) Provisional application No. 63/685,913, filed on Aug. 22, 2024.
(60) Provisional application No. 63/733,705, filed on Dec. 13, 2024.

(51) Int. Cl. G09F 3/14; G09F 3/00; G09F 3/02

(52) U.S. Cl. CPC G09F 3/14; G09F 3/0295; G09F 2003/023

(57) ABSTRACT

This document describes techniques and apparatuses for marking labels that are configured to provide for the manipulation of an object (e.g., a cable) by a tool. The marking labels are configured to attach to the object and are directionally positionable on the object. In one aspect, a label includes a tool hole and a mount portion. The tool hole is defined in the label and is sized to receive a tool that is configured to manipulate an object by the label. The mount portion is configured to attach to the object and is configured to orient the label relative to the object to position the tool hole in a location spaced apart from the object.

### CROSS-REFERENCE TO RELATED APPLICATIONS

This application claims the benefit of U.S. Provisional Patent Application Ser. No. 63/733,705, filed on Dec. 13, 2024, and the benefit of U.S. Provisional Patent Application Ser. No. 63/685,913, filed on Aug. 22, 2024, the disclosures of which are incorporated by reference herein in their entireties.

### BACKGROUND

In industrial, commercial, and other settings, cables are regularly marked with identification information to prevent switching errors, equipment damage, and/or personnel injury, especially in high-voltage systems. For example, a technician (e.g., a utility linemen, an electrician) may apply a marking label (e.g., tag, marker, identifier) to one or more of the cables to provide identification information (e.g., circuit identity, voltage rating, phase designation, source/destination equipment designations, type of signal carried, installation dates, maintenance dates, and the like) related to the cable.

A first example common type of cable marking is an engraved plastic tag (e.g., an engraved phenolic plastic tag) that is secured to the cable using a chain or a cable tie. Such a tag may be engraved on one side, which makes it harder to find a target cable if the tag is facing away from the technician, is dirty and full of mud, and/or is half-hidden by other cables. A second example common type of cable marking is stamped (embossed) brass tags. Stamped brass tags frequently have many of the same issues as engraved plastic tags but may be more unreadable because the stampings do not contrast with the surface of the label, which can make them difficult to read at close range. Additionally, dirt may accumulate in the engravings and/or embossing, making them difficult to read, which can result in the technician spending time cleaning the tag to make it readable. Further, tags frequently fall off cables, leaving cables unidentified and forcing the technician to test every cable in order to find the correct circuit.

### SUMMARY

This document describes techniques and apparatuses for marking labels that are configured to provide for the manipulation of an object (e.g., a cable) by a tool. The marking labels are configured to attach to the object and are directionally positionable on the object.

In some implementations, a marking label includes a tool hole and a mount portion. The tool hole is defined in the label and sized to receive a tool configured to manipulate an object by the label. The mount portion is configured to attach to the object and configured to orient the label relative to the object to position the tool hole in a location spaced apart from the object.

In some implementations, a marking label includes a tail portion and a mount portion. The tail portion includes a tool hole defined through the tail portion and sized to receive a tool configured to lift an object by the label. The mount portion is integral to the tail portion and is configured to form a loop around the object.

In some implementations, a marking label includes a tail portion and a mount portion. The tail portion includes at least one indicia portion configured to receive indicia and includes a tool hole defined through the tail portion and sized to receive a tool configured to lift an object by the label to display the indicia. The mount portion is integral to the tail portion and includes a loop portion and a slot. The loop portion is configured to form a loop around the object and includes at least one first notch in a first side edge of the mount portion and at least one second notch in a second side edge of the mount portion. The second side edge is opposite the first side edge and the second notch is opposite the first notch. The slot is defined through the mount portion and configured to receive the tail portion therethrough to form the loop around a portion of the object. The slot defines a first sidewall opposite a second sidewall, the first and second sidewalls configured for respective receipt into the first and second notches of the loop portion when the label is inserted through the slot to restrain the label in the slot.

This Summary is provided to introduce simplified concepts of techniques and apparatuses for marking labels, which are further described below in the Detailed Description and are illustrated in the Drawings. This Summary is not intended to identify all implementations of marking labels described in the Detailed Description and illustrated in the Drawings. This Summary is also not intended to identify essential features of the claimed subject matter. Further, this Summary is not intended for use in determining the scope of the claimed subject matter.

### BRIEF DESCRIPTION OF THE DRAWINGS

The details of one or more implementations of marking labels that are configured to provide for the manipulation of an object (e.g., a cable) by a tool are described with reference to the following Drawings.

FIG. 1 is a schematic representation of a first marking label.

FIG. 2 is a perspective, environmental view of a second marking label, which illustrates the marking label attached to a cable and manipulated by a tool.

FIG. 3A is a first side view of a third marking label in an unfolded configuration.

FIG. 3B is a second side view of the third marking label of FIG. 3A.

FIG. 3C is a first side view of the third marking label of FIG. 3A, in a folded configuration.

FIG. 4 is a first side view of a fourth marking label.

FIG. 5 is a first side view of a fifth marking label.

FIGS. 6A-6F are sequential illustrations of an example installation of a marking label on an object.

### DETAILED DESCRIPTION

Electrical infrastructure (e.g., utility boxes, electrical panels, junction boxes, underground maintenance holes, cable vaults) is frequently located in challenging environments. For example, a cable vault may be located in an enclosed, confined, dark, underground location in the presence of water and chemical contaminants (e.g., water, aircraft deicing fluid). Identification information on cables in electrical infrastructure allows a technician to precisely identify individual cables within electrical infrastructure. Identification may be necessary for safety, maintenance (e.g., tracing a circuit and troubleshooting faults, for replacing circuit components), and/or inspection (e.g., for regulatory compliance) purposes.

Even when properly labeled and placed within a clear line-of-sight of a maintenance hole cover opening or other technician access point, the number of cables routed within electrical infrastructure and environmental conditions (e.g., darkness, wetness) can pose a challenge for a technician to identify a particular cable easily and safely during maintenance, repair, and/or inspection procedures. When the identification of cables is unclear, in some situations, safety standards may necessitate the use of lockout and/or tagout procedures to de-energize the system, the use of testing equipment to verify zero voltage is present, and the wearing of suitable personal protection equipment (PPE) by the technician before handling cables. Typical PPE includes a helmet, a face shield, boots, gloves, and a heavy jacket. The thick PPE gloves can make it difficult for the technician to orient labels for readability. Taking actions to meet such safety standards can take additional time and labor.

Disclosed are techniques and apparatuses for marking labels that are configured to attach to an object (e.g., an electrical cable, a conductor, a wire) to provide for the manipulation of the object and/or the marking label, utilizing a tool, without contacting the object itself. In one example, the disclosed techniques and apparatuses include a marking label that is configured to attach to a cable to enable a technician to utilize a tool to manipulate the marking label to read indicia on the marking label to identify an object without the technician physically contacting the object. In aspects, the marking labels are directionally positionable on the object relative to the object to facilitate such manipulation.

In this way, the disclosed techniques and apparatuses make it easier for a technician to find a target cable if the marking label is facing away from the technician, it is partially hidden by other cables, and the like, saving the technician time. The disclosed techniques and apparatuses also make it safer for the technician to identify cables. For example, when the cable is a high-voltage cable, the technician can manipulate the label attached to the object to read the label and identify it without touching the cable itself. This may decrease the chances that the technician will be exposed to dangerous conditions. In aspects, this may also mean the technician does not have to put on personal protective equipment (PPE) before identifying the cable by the indicia on the label, which saves the technician time.

Unlike labels with embossed and/or engraved indicia, the disclosed techniques and apparatuses make it easier for a technician to read the label without first cleaning the label to remove dirt and other indicia-obscuring material from the label, saving the technician time and effort during installation and maintenance, minimizing the risk of errors during switching (e.g., connection and disconnection), improving system reliability, enabling rapid diagnosis and repair, reducing downtime, and increasing safety.

These are but some examples of techniques and apparatuses for marking labels that are configured to attach to an object to provide for the manipulation of the object and/or the marking label, utilizing a tool, without contacting the object itself. Other examples and implementations are described throughout this document.

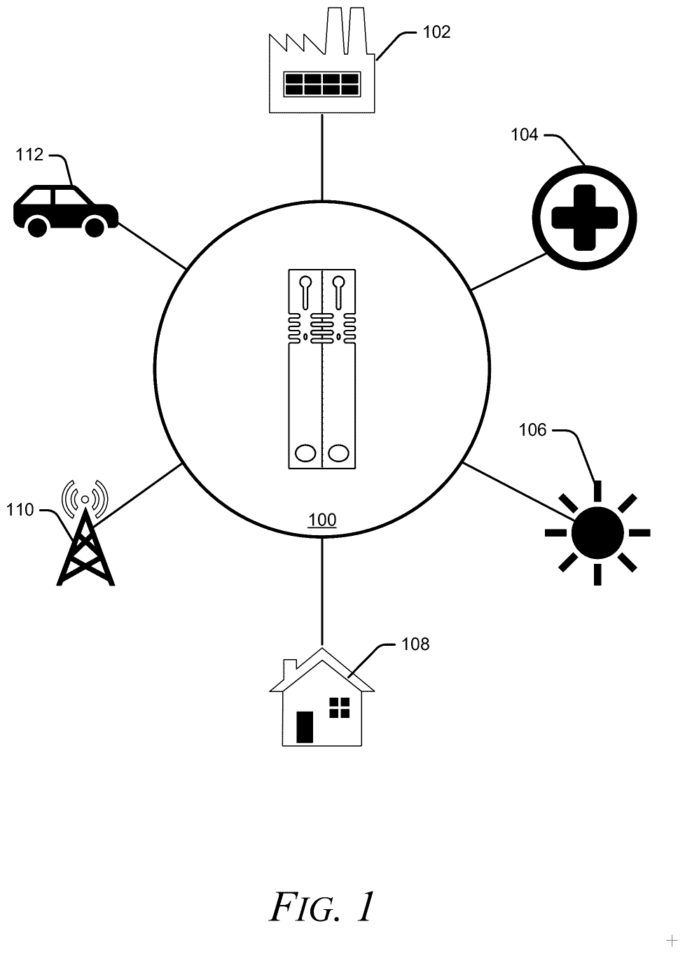

FIG. 1 is a schematic representation of a marking label 100 (label 100) that is configured to provide for the manipulation of an object by a tool. As discussed herein, the label 100 may have particular application in energy and utility markets 106 (e.g., for the manipulation of cables within electrical infrastructure utility boxes through use of an insulated disconnect stick). While this disclosure, including the Drawings, references these markets, the label 100 may have application to objects and bundles of objects in other markets, including but not limited to industrial and manufacturing markets 102, healthcare markets 104, consumer and commercial markets 108, telecommunications and data infrastructure markets 110, and/or transportation markets 112.

The industrial and manufacturing markets 102 include industrial automation and equipment, control panels, machine building, machinery, electrical enclosures, material handling systems (e.g., conveyors), cooling systems, heavy equipment (e.g., construction and mining machinery), agricultural technology (e.g., farming equipment), chemical (e.g., chemical processing equipment), robotics (e.g., automated robotic systems), original equipment manufacturers (OEMS), mechanical components, and mechanical systems. The healthcare markets 104 include medical equipment and technology, and dental equipment and technology. The energy and utility markets 106 include renewable energy systems (e.g., solar, wind, hydroelectric), power generation and distribution, industrial lighting, and commercial lighting. The consumer and commercial markets 108 include appliances (e.g., home and commercial appliances), heating, ventilation, and air conditioning (HVAC), and consumer electronic devices. The telecommunications and data infrastructure markets 110 include telecommunications (e.g., general telecom services), communications (e.g., communication systems and equipment), internet service providers (ISPs), cable television companies (CATV), infrastructure for data storage and processing (e.g., data centers), broadband (e.g., broadband internet services), and datacom (e.g., data communications equipment). The transportation markets 112 include manufacturing and components for vehicles, trucks, automobiles, rail conveyances (e.g., trains), marine craft (e.g., ships, boats), aircraft, and aerospace.

The following discussion describes an operating environment, techniques that may be employed in the operating environment, and various devices or systems in which components of the operating environment can be embodied. In the context of the present disclosure, reference is made to the operating environment by way of example only.

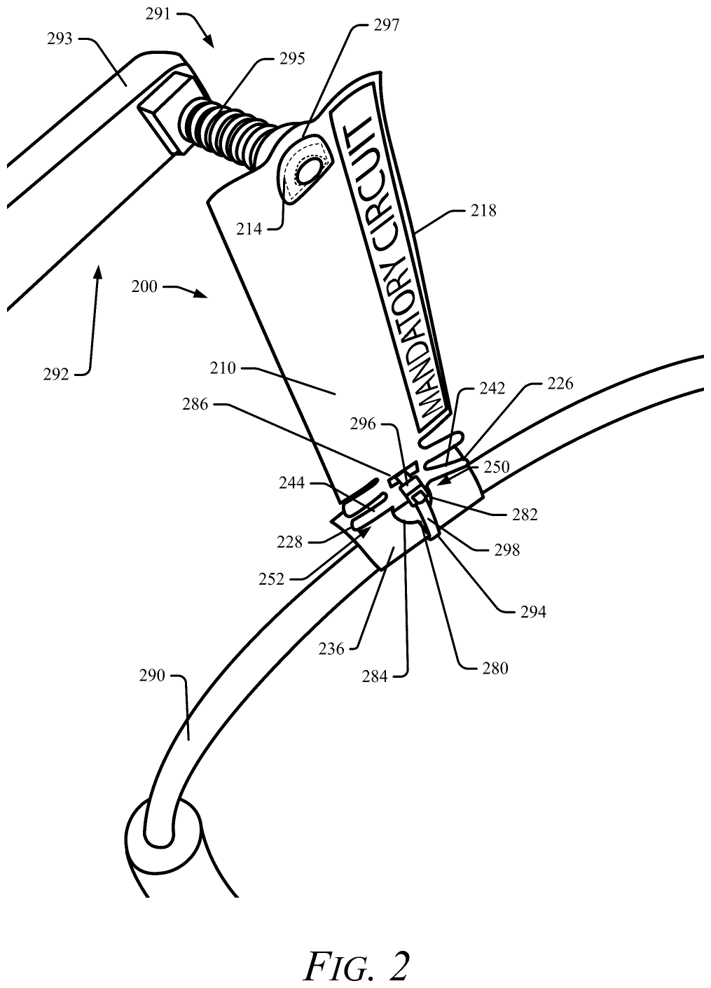

FIG. 2 is a perspective, environmental view of a marking label 200 (label 200). The figure illustrates the marking label 200 attached to an object 290 (e.g., a cable) and manipulated by a tool 292. Examples of suitable tools configured for use to manipulate a label include, but are not limited to, hot switch sticks, hot sticks, hook sticks, insulated disconnect sticks, sticks configured for operation of open-air disconnect switches, universal switch sticks, non-conductive probe sticks, and the like that are configured to allow a technician to manipulate an energized conductor and/or equipment from a safe distance.

The label 200 includes a tool hole 214 that is defined in the label 200 and sized to receive the tool 292 configured to manipulate the object 290 by the label 200, for example, during installation, rework, maintenance, and/or repair. As used herein, the description of the manipulation of a label attached to an object may also include the manipulation of the object itself. The tool hole 214 may be located on the label 200 distal to the object 290 when the label 200 is installed on the object 290.

The label 200 also includes a mount portion 236 that is configured to attach to the object 290. The mount portion 236 is configured to orient the label 200 relative to the object 290 to position the tool hole 214 in a location (e.g., a desired orientation) that is spaced apart from the object 290. The location may be positioned to make it easier for the technician to grab or otherwise manipulate the label 200 using the tool 292. The tool hole 214 may be defined within a tail portion 210 of the label 200.

In aspects, the mount portion 236 and the tail portion 210 are formed from label material (e.g., printable plastic, polymeric material). The mount portion 236 may be integral to the tail portion 210. The label material may include a face stock with a face surface configured to accept a marking material (e.g., ink, paint, dye, coloring, markings, textures, and the like). In aspects, the face stock is configured to receive marking material from a printer (e.g., a thermal transfer printer, a direct thermal printer, a laser printer, an inkjet printer, a dot matrix printer) and/or a writing instrument (e.g., a pen, a pencil, a permanent marker, a marking pen). The face stock may be printable on both sides. A back surface of the face stock may be bonded to a layer of adhesive (e.g., an adhesive portion) carried on a backing sheet. The back surface may be opposite the face surface. In one example, the label material is a self-laminating thermal transfer adhesive label.

In aspects, labels (e.g., label 200) may be field-printable (e.g., printable on demand), which may eliminate the need for a technician to sort through a stack of preprinted labels to find the correct label needed. The labels may be printable on both sides, so that they can be read in any orientation. The labels may be made of a reflective material and/or include indicia that are highly visible using a flashlight. The labels may include color indicia that are coded (e.g., color-coded) to differentiate different circuits, which may further narrow a technician's search for a specific cable. For example, in runway lighting infrastructure installation, a yellow color may indicate elevated runway edge lights that denote the last 3000 feet (approximately 914.4 meters) of the runway; a white color may indicate elevated runway edge lights that denote up until the last 3000 feet of the runway; a blue color may indicate elevated taxi way edge lights; a red color may indicate a mandatory circuit; a green color may indicate center line lights; and the like. In implementations, the indicia and/or the label may not include color.

The mount portion 236 is configured to attach to the object 290. For example, the mount portion 236 may be configured to loop around the object 290 to attach the label 200 to the object 290. The mount portion 236 is further configured to orient the label 200 relative to the object 290. For example, the mount portion 236 may be configured to orient the label 200 relative to the object 290 to position the tail portion 210 of the label 200 (e.g., the tool hole 214 defined in the tail portion 210 of the label 200) in a location that is spaced apart from the object 290. In this way, the tail portion 210 may be positioned to extend away from the mount portion 236.

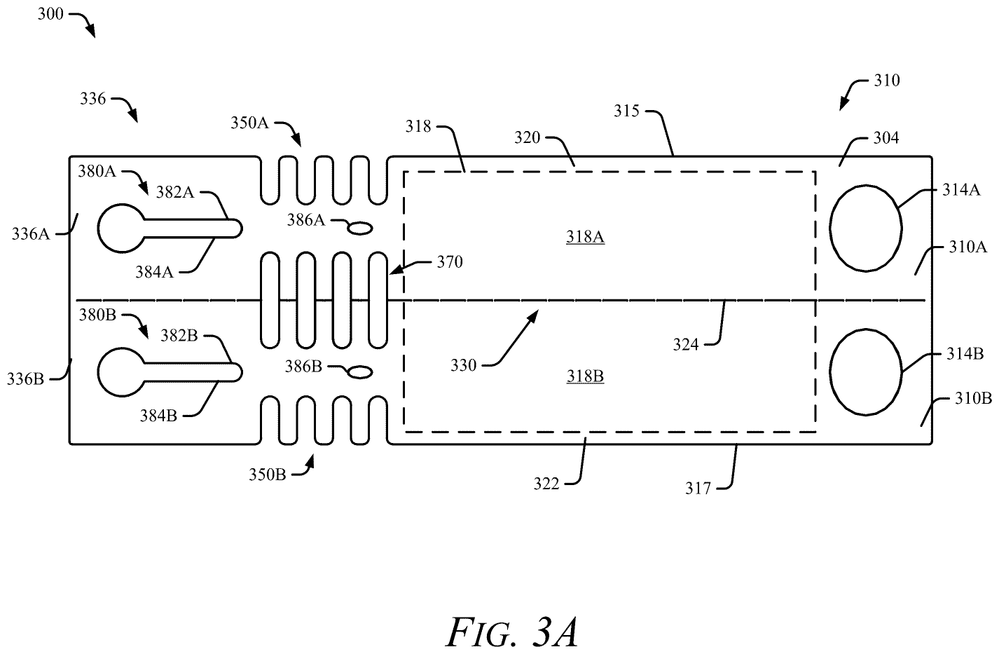

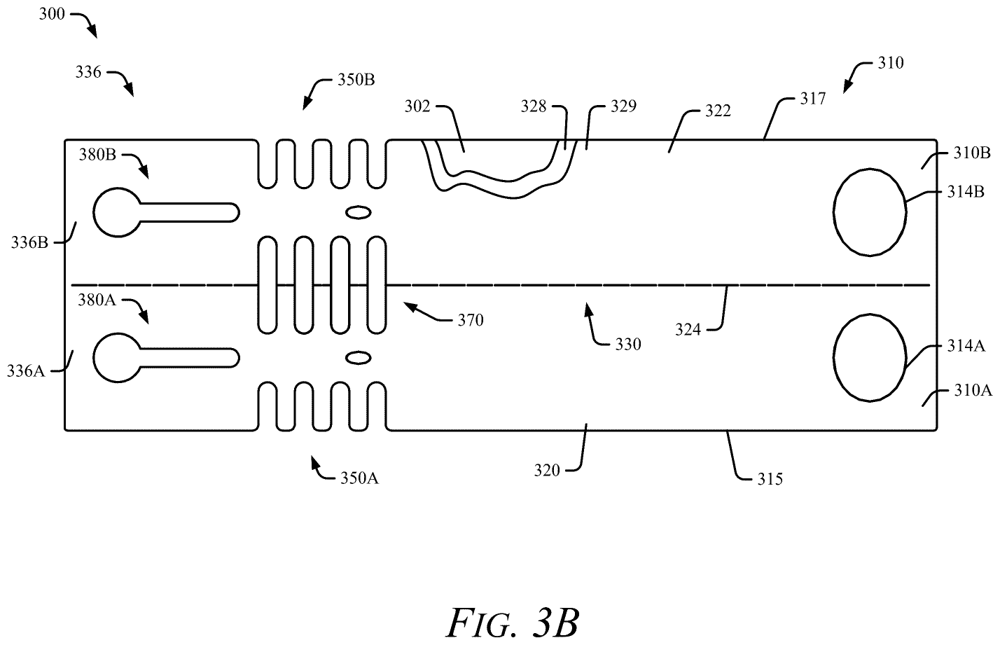

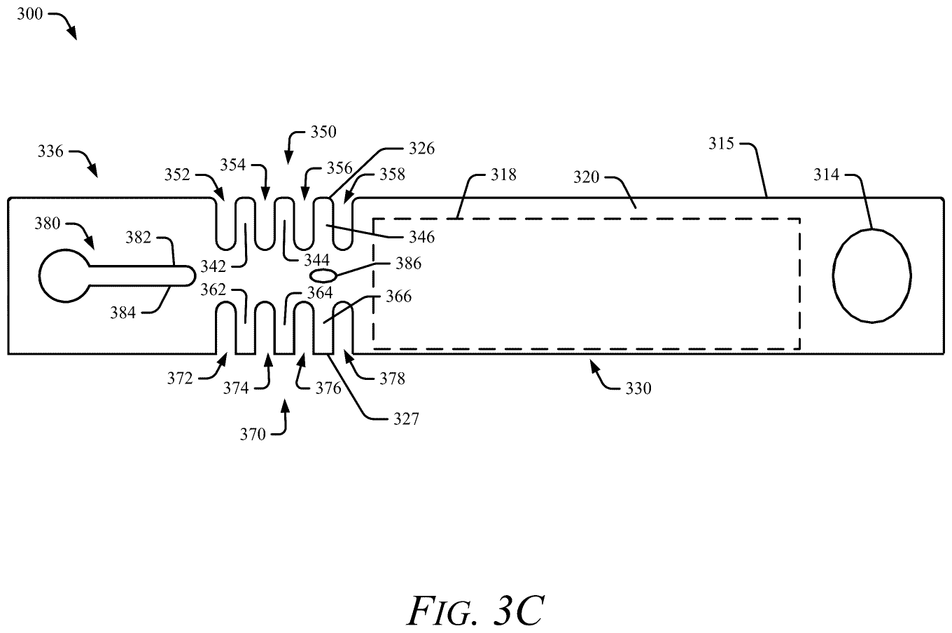

As discussed above, the mount portion 236 is configured to attach to the object 290 to orient the label 200 relative to the object 290 and position the tool hole 214 in a location (e.g., a desired orientation) that is spaced apart from the object 290. In aspects, the marking label 200 is directionally positionable on the object 290. For example, a strap 294 (optional) may cinch the marking label 200 onto the object 290 to limit and/or prevent a rotation of the marking label 200 relative to the object 290, as also discussed in detail with respect to a marking label 300 (label 300) illustrated in FIGS. 3A-3C and described below. The utilization of the strap 294 may more permanently fix the position of the tail portion 210 relative to the object 290 as it extends from the object 290 to directionally position the marking label 200 on the object 290.

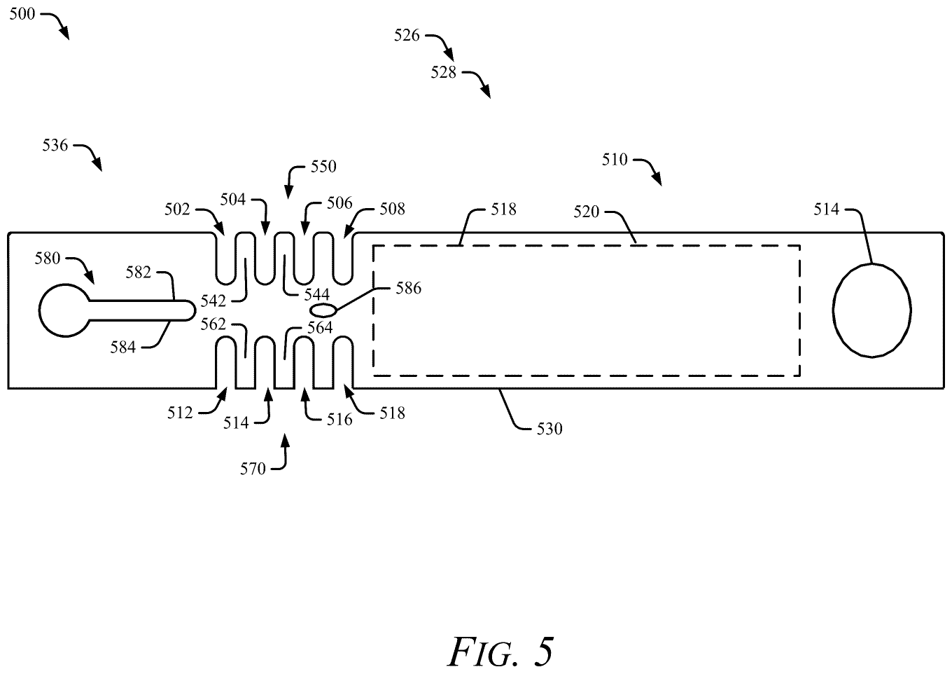

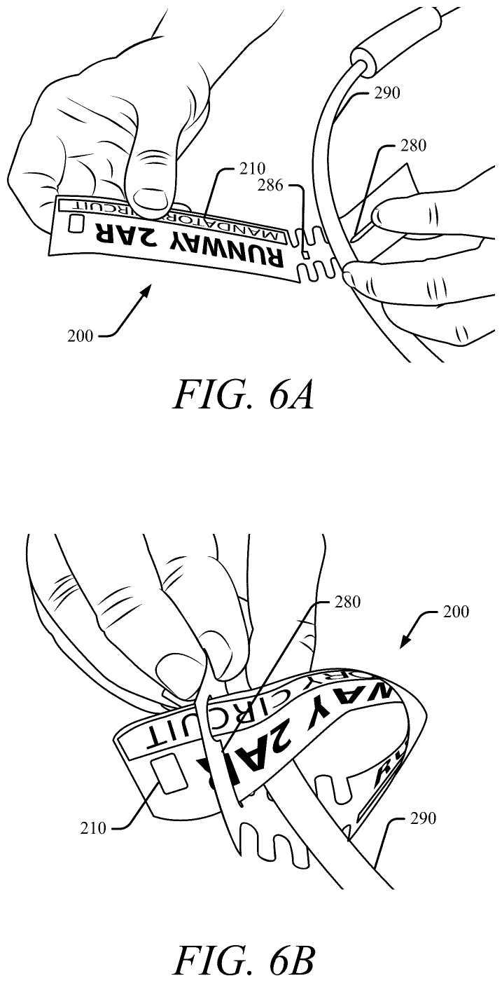

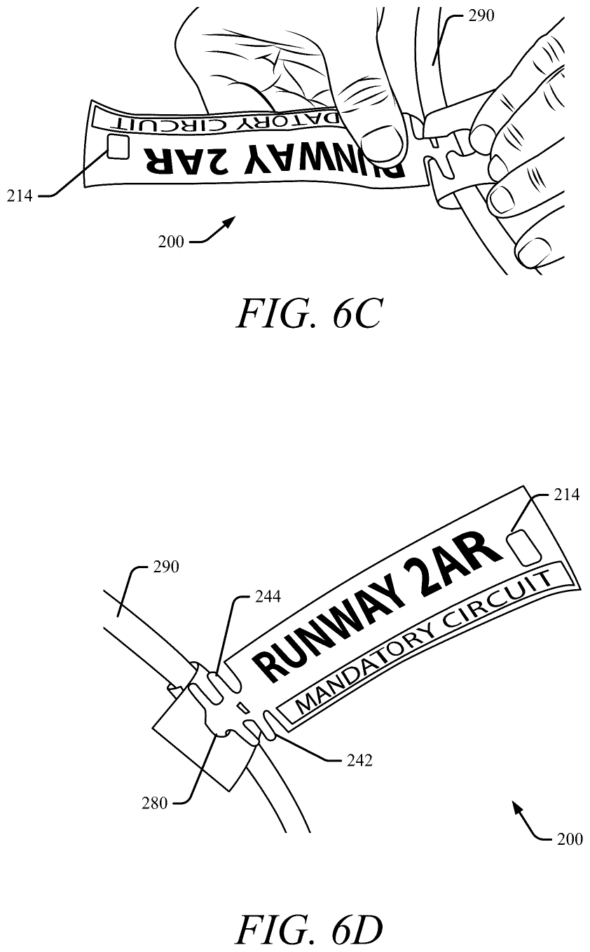

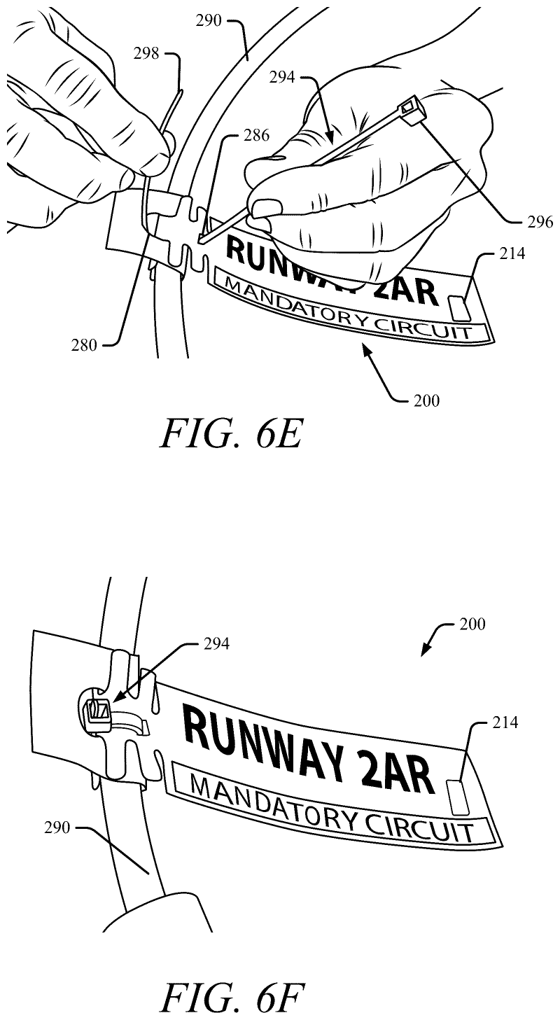

The marking label 200 may include at least one strap hole 286 defined through the mount portion 236. The strap hole 286 is configured to receive a strap (e.g., strap 294) therethrough to cinch a loop portion to the object 290 to orient the label 200 in an angular position relative to the object 290 to present the label 200 in a position away from the object 290. In aspects, the strap 294 is a cable tie, and the strap hole 286 and a slot 280 are both configured to receive a tail 298 of the strap 294 therethrough to cinch the loop portion to the object 290 to orient the label 200 in an angular position relative to the object 290 to present the label 200 in a position away from the object 290. The strap hole 286 may be any geometric shape, including but not limited to openings in the label 200 (e.g., slits), polygonal shapes (e.g., square shape), shapes bounded by curves (e.g., ovular shapes), and combinations of the same (e.g., a keyhole shape). The strap hole 286 is further illustrated in FIGS. 6A-6F.

As used herein, the term “strap” is used to refer to all types and forms of strapping materials, including but not limited to cable ties, plastic bands, metal bands, string, twine, wire, hook-and-loop fastener straps, and the like. In FIG. 2, FIG. 6E, and FIG. 6F, the strap (e.g., strap 294) is illustrated as a cable tie that includes a head end and a tail end. The head end includes a locking head (e.g., head 296) and the tail end includes an elongated strap portion (e.g., tail 298) that extends from the locking head. The strap portion may be configured for insertion through the locking head to form a loop (e.g., a loop through the marking label and around the object). In implementations, a marking label may utilize a strap. In other implementations, a strap may be omitted.

The marking label (e.g., the tail portion 210) may include at least one indicia portion (e.g., indicia-receiving portion) that is configured to receive indicia. For example, the marking label may include a first indicia portion 218. The at least one indicia portion may include one or more indicia (e.g., lines, symbols, numbers, letters, machine-readable codes, QR codes, bar codes, color, patterns, and the like). Indicia may be formed of a marking material (e.g., ink). The indicia portion may include one or more colors (e.g., a high-resolution color, a reflective color, a color that glows under black light). The indicia portion may be provided on one or more sides of the tail portion 210. For example, the tail portion 210 may include a first indicia portion (e.g., indicia portion 218) on a first side and a second indicia portion on a second side (not illustrated in FIG. 2). In implementations, an indicia portion may be omitted from a marking label.

The tool 292 may include an elongated non-conductive pole (e.g., pole 293) configured for handling at a first end by the technician and may include a second end that terminates at a head 291 (e.g., a disconnect head). The head 291 may include a probe portion 295 (e.g., a hook, a dead hook, a probe, a prong) that may terminate at a tip 297. By using the probe portion 295 of the tool 292 to engage the tool hole 214, an individual object 290 and/or the label 200 may be lifted or moved without the technician touching the object 290. As a result, the technician may not need to put on their personal protection equipment (PPE) until they have found and identified the target object(s). For example, a technician may investigate a plurality of cables located within a utility vault to determine the identities of the cables before donning PPE to handle a high-voltage cable discovered within the utility vault.

The tool hole 214 is defined in the label 200, for example, in the tail portion 210. The tool hole 214 may be any geometric shape, including but not limited to openings in the label 200 (e.g., slits), polygonal shapes (e.g., square shape), and shapes bounded by curves (e.g., ovular shapes). In aspects, the tool hole 214 extends from a top surface of the label 200 to a bottom surface of the label 200 (e.g., a bottom surface of the face stock, a bottom surface of an adhesive portion, a bottom surface of a backing sheet of an adhesive portion).

The tool hole 214 is sized to receive the tool 292 (e.g., to receive the probe portion 295 and/or the tip 297 of the tool 292). The tool 292 is configured to manipulate (e.g., lift, move, adjust, reposition, push, pull, grab) the label 200 and/or an object 290 attached to the label 200. For example, a technician (e.g., electrician) may use the tool 292 to engage the tool hole 214 in the label 200 to lift, move, or manipulate the object 290 and/or the label 200 to investigate the installation, thus eliminating the need to touch live electrical cables in wet environments. For example, the tool hole 214 may be configured to allow the use of the tool 292 to capture the label 200 from a distance while inside a recessed area, such as a utility hole or vault, or in any confined area where cables are mixed, randomized, or condensed.

The mount portion 236 may include at least one notch in a side edge of the mount portion 236 (e.g., first notch 250 in a first side edge 226, second notch 252 in a second side edge 228). In such a configuration, the second side edge 228 may be positioned opposite the first side edge 226 and the at least one second notch 252 may be positioned opposite the at least one first notch 250. The label 200 may be elongated, and the first notches 250 and/or the second notches 252 may extend perpendicular to, generally perpendicular to, or at an angle to a length of the label 200. The first notches 250 and the second notches 252 may be aligned in pairs. In implementations, a marking label has at least one notch in a side edge of the mount portion 236. In other implementations, a notch in a side edge of the mount portion 236 may be omitted, for example as illustrated and described with respect to a label 400 of FIG. 4 herein.

The mount portion 236 may include the slot 280 defined through the mount portion 236 and configured to receive the tail portion 210 therethrough to form a loop around a portion of the object 290 to attach the label 200 to the object 290. The slot 280 may define a sidewall that is configured for receipt into the at least one notch when the label 200 is inserted through the slot 280 to restrain the label 200 in the slot 280. For example, the at least one notch may include the first notch 250 and second notch 252, and the at least one sidewall may include a first sidewall 282 and second sidewall 284, with the first sidewall 282 configured for receipt into the first notch 250 and the second sidewall 284 configured for receive into the second notch 252. The mount portion 236 may include at least one finger defined between adjacent notches. A finger may be configured to limit a movement of the mount portion 236 relative to the slot 280. In FIG. 2, the mount portion 236 includes a first finger 242 defined between a primary first notch and a secondary first notch and a second finger 244 defined between a primary second notch and a secondary second notch. In this way, when the label 200 is inserted through the slot 280, the notch(es), finger(s), and/or sidewall(s) restrain the label 200 in the slot 280. In implementations, a marking label has a slot. In other implementations, a slot may be omitted.

Similarly to the label 300 described herein and illustrated in FIGS. 3A-3C, the first notch 250 may include a plurality of first notches and the second notch 252 may include a plurality of second notches. An aligned first pair of the first and second notches may be configured for receipt into the slot 280 to respectively engage the first sidewall 282 and the second sidewall 284 to define a first diameter loop around the portion of the object 290, and an aligned second pair of the first and second notches may be configured for receipt into the slot 280 to respectively engage the first sidewall 282 and the second sidewall 284 to define a second diameter loop around the portion of the object 290. In such a configuration, the first diameter loop is smaller than the second diameter loop.

Referring now to FIGS. 3A, 3B, and 3C, illustrated is a third marking label (label 300) that is configured to provide for the manipulation of an object (e.g., object 290) by a tool (e.g., tool 292). The third marking label 300 is similar to the second marking label 200 illustrated in FIG. 2 and described above, except as detailed below. Thus, the marking label 300, as illustrated in FIG. 3C, includes a tail portion 310, a tool hole 314, a first indicia portion 318, a first side edge 326, a second side edge 327, a mount portion 336, a first notch 350, a second notch 370, a slot 380, a first sidewall 382, and a second sidewall 384.

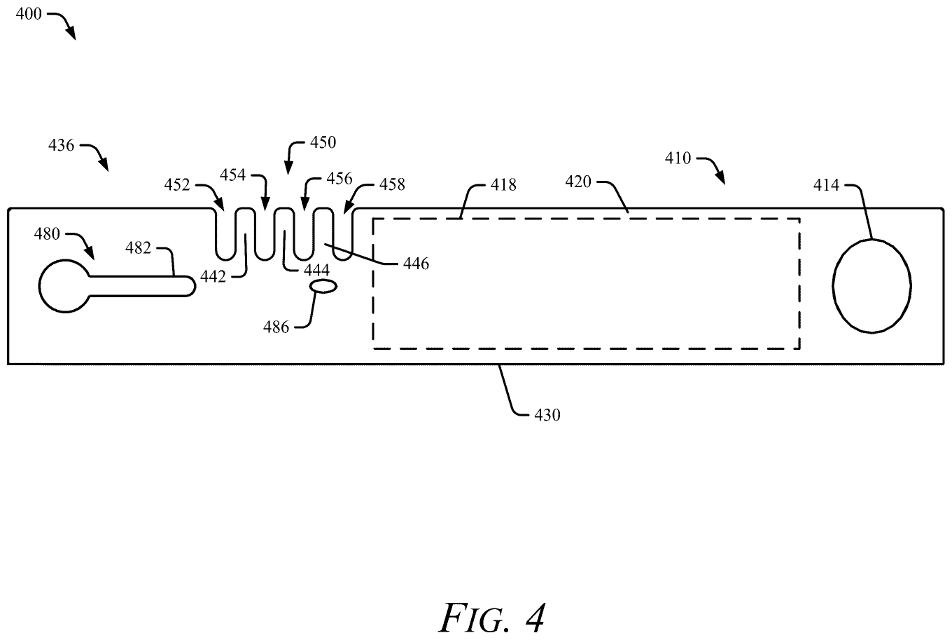

FIG. 3A is a first side view of the label 300. FIG. 3B is a second side view of the label 300. Both FIG. 3A and FIG. 3B illustrate the label 300 in an unfolded configuration. FIG. 3C is a first side view of the label 300, which illustrates the label 300 in a folded configuration. The label 300 includes a first label member 320 and second label member 322, as illustrated in FIGS. 3A and 3B. The label 300 includes a folding portion 330 that is configured to foldably connect the first label member 320 and the second label member 322. In aspects, a label may not include a folding portion. For example, a label 500 illustrated in FIG. 5 and discussed below does not include a folding portion.

The label 300 includes a face stock with a second side (e.g., second side 302, face surface) opposite a first side (e.g., first side 304, back surface). FIG. 3A illustrates the first side 304 of the label 300 and FIG. 3B illustrates the second side 302 of the label 300. The first side 304 of the face stock is configured to receive marking material from a printer and/or a writing instrument. The second side 302 of the face stock is bonded to a layer of adhesive (e.g., at least one adhesive portion 328), as illustrated in FIG. 3B. The adhesive portion 328 may include a suitable adhesive (e.g., acrylic adhesive). The first label member 320 is configured to fold over the second label member 322, or vice versa, at the folding portion 330 to adhere the first label member 320 to the second label member 322 via the at least one adhesive portion 328 to form the folded configuration, as illustrated in FIG. 3C. The adhesive portion 328 may be covered by a backing sheet 329 (e.g., removable liner), which may be formed of polyester, polypropylene, polyethylene, kraft paper, or another material, and may be coated with a release agent (e.g., silicone). In aspects, the folding portion 330 is defined along a centerline 324 between the first label member 320 and the second label member 322, as illustrated in FIGS. 3A and 3B. The centerline 324 may be spaced between a first side 315 of the first label member 320 and a second side 317 of the second label member 322.

As discussed above, the label 300 includes the first label member 320, the second label member 322, and the folding portion 330 that is configured to foldably connect the first label member 320 and the second label member 322. The first label member 320 includes a tail portion 310A, a tool hole 314A, a first indicia portion 318A, a mount portion 336A, a first notch 350A, a slot 380A, a first sidewall 382A, and a second sidewall 384A. The second label member 322 includes a tail portion 310B, a tool hole 314B, a first indicia portion 318B, a mount portion 336B, a first notch 350B, a slot 380B, a first sidewall 382B, and a second sidewall 384B. The first label member 320 may include similar structures to the second label member 322, which are positioned adjacently to one another when the label 300 is folded at the folding portion 330, as described herein. For example, in the folded configuration, the tail portion 310A and tail portion 310B together form the tail portion 310, the tool hole 314A and tool hole 314B together the form tool hole 314, the mount portion 336A and mount portion 336B together form the mount portion 336, the first notch 350A and first notch 350B together form the first notch 350, the first sidewall 382A and first sidewall 382B together form the first sidewall 382, and the second sidewall 384A and second sidewall 384B together form the second sidewall 384, which are illustrated in FIG. 3C. The slot 380A and slot 380B together form the slot 380, which is illustrated in FIG. 3C. In FIGS. 3A and 3B, the indicia portion 318 includes a first indicia portion 318A and/or a second indicia portion 318B. In the folded configuration, the first indicia portion 318A and second indicia portion 318B together form the indicia portion 318, which is illustrated in FIG. 3C. In implementations, an indicia portion may be omitted.

The mount portion 336 may include a loop portion that is configured to form a loop around the object. The loop portion includes at least one first notch 350 in a first side edge 326 of the mount portion 336 and at least one second notch 370 in a second side edge 327 of the mount portion 336, as illustrated in FIG. 3C. The second side edge 327 is opposite the first side edge 326 and the second notch 370 is opposite the first notch 350. The first notch 350 may include a primary first notch 352, a secondary first notch 354, a tertiary first notch 356, and a quaternary first notch 358. The second notch 370 may include a primary second notch 372, a secondary second notch 374, a tertiary second notch 376, and a quaternary second notch 378.

The mount portion 336 may include at least one finger defined between adjacent notches. The finger may be configured to limit a movement of the mount portion 336 relative to the slot 380. The mount portion 336 may include a first finger 342 defined between the primary first notch 352 and the secondary first notch 354, the first finger 342 configured to limit the movement of the mount portion 336 relative to the slot 380. The mount portion 336 may include a second finger 362 defined between the primary second notch 372 and the secondary second notch 374, the second finger 362 configured to limit the movement of the mount portion 336 relative to the slot 380. The mount portion 336 may include a third finger 344 defined between the secondary first notch 354 and the tertiary first notch 356, the third finger 344 configured to limit the movement of the mount portion 336 relative to the slot 380. The mount portion 336 may include a fourth finger 364 defined between the secondary second notch 374 and the tertiary second notch 376, the fourth finger 364 configured to limit the movement of the mount portion 336 relative to the slot 380. The mount portion 336 may include a fifth finger 346 defined between the tertiary first notch 356 and the quaternary first notch 358, the fifth finger 346 configured to limit the movement of the mount portion 336 relative to the slot 380. The mount portion 336 may include a sixth finger 366 defined between the tertiary second notch 376 and the quaternary second notch 378, the sixth finger 366 configured to limit the movement of the mount portion 336 relative to the slot 380. A label may include fingers that are used to optionally secure the label to a cable.

The mount portion 336 may include the slot 380 defined through the mount portion 336 and configured to receive the tail portion 310 therethrough to form a loop around a portion of the object (e.g., object 290) to attach the label 300. In aspects, the slot 380 is keyhole shaped and the width of the label 300 is greater than the length of the slot 380. The slot 380 defines a sidewall that is configured for receipt into at least one notch of the loop portion when the label 300 is inserted through the slot 380 to restrain the label 300 in the slot 380. For example, the slot 380 may define a first sidewall 382 opposite a second sidewall 384, the first and second sidewalls 382, 384 configured for respective receipt into the first and second notches of the loop portion when the tail portion 310 is inserted through the slot 380 to restrain the tail portion 310 in the slot 380. The at least one notch may include the first notch 350 and the second notch 370 and the at least one sidewall may include the first sidewall 382 and second sidewall 384, with the first sidewall 382 configured for receipt into the first notch 350 and the second sidewall 384 configured for receive into the second notch 370. In this way, when the label 300 is inserted through the slot 380, the notch(es) and sidewall(s) restrain the label 300 in the slot 380. In implementations, the marking label 300 has a slot. In implementations, a slot may be omitted.

In aspects, the marking label 300 is directionally positionable on the object (e.g., object 290). For example, a strap 294 (optional) may cinch the marking label 300 onto the object to limit and/or prevent a rotation of the marking label 300 relative to the object. The utilization of the strap 294 may more permanently fix the position of the tail portion 310 relative to the object as it extends from the object to directionally position the marking label 300 on the object. In one example, the marking label 300, as illustrated in FIG. 3C, may include at least one strap hole 386 defined through the mount portion 336. The strap hole 386 is configured to receive a strap (e.g., strap 294, strap 694) therethrough to cinch the loop portion to the object to orient the label 300 in an angular position relative to the object to present the label 300 in a position away from the object. In aspects, the strap (e.g., strap 294) is a cable tie and the strap hole 386 and the slot 380 are both configured to receive a tail (e.g., tail 298) of the strap therethrough to cinch the loop portion to the object to orient the label 300 in an angular position relative to the object to present the label 300 in a position away from the object (e.g., as illustrated in FIGS. 6E and 6F). The strap hole 386 may be any geometric shape, including but not limited to openings in the label (e.g., slits), polygonal shapes (e.g., square shape), shapes bounded by curves (e.g., ovular shapes), and combinations of the same (e.g., a keyhole shape). The marking label 200 illustrated in FIG. 2 also includes at least one strap hole 286 defined through the mount portion 236. The strap hole 386 may include a first strap hole 386A of the first label member 320 positioned adjacent to a second strap hole 386B of the second label member 322, when the label 300 is folded at the folding portion 330, as described herein.

The label 300 includes a strap hole 386 configured to allow a strap to provide additional securement to the object. The strap hole 386 is configured to accommodate a strap (e.g., cable tie), which may be used to lock the label 300 in a particular orientation, ensuring the label 300 is readable by the technician (e.g., from a vault access point, from any point of reference to ensure all labels are visible). The strap hole 386 may also ensure that the tool hole 314 is positioned for easy access by a probe tip of a probe stick. The tail of the cable tie is inserted through the strap hole 386 after the label 300 is installed onto the object, and the tail is then inserted through the slot 380 and back around the object until it engages the head of the cable tie, making a full circle around the label 300 and the object (e.g., cable).

The strap hole 386 may be positioned near the fingers, which allow a standard cable tie (e.g., twist tie) to be inserted and looped around the label 300 to secure it to the cable. A cable tie may be utilized to lock the label 300 at a specific angle after installation. The use of the strap hole 386 further helps to position the printed label 300 relative to the technician's point of view, thus exposing as many labels as possible to the point of entry so that technicians can quickly find and secure a particular label and cable. Labels can be additionally secured by the use of a cable tie, inserted through the strap hole 386 to position the label into a specific position for higher visibility after installation. By using a cable tie, the label can be permanently positioned at any angle, so that future workers can read the labels from a specific point or position above, below, or from any angle relative to the label as required to maximize readability. This also improves safety by reducing a movement of a cable to specific and easy-to-find targets.

Referring now to FIG. 4, a fourth marking label 400 (label 400) that is configured to provide for the manipulation of an object (e.g., object 290) by a tool (e.g., tool 292) is illustrated. The fourth marking label 400 is similar to the second marking label 200 illustrated in FIG. 2 and the third marking label 300 illustrated in FIGS. 3A-3C and described above, except as detailed below. Thus, the marking label 400 includes a tail portion 410, a tool hole 414, a first indicia portion 418, a label member 420, a first side edge 426, a folding portion 430, a mount portion 436, a first notch 450, a slot 480, a first sidewall 482, and a strap hole 486.

The mount portion 436 may include a loop portion that is configured to form a loop around the object. The loop portion includes at least one first notch 450 in a first side edge 426 of the mount portion 436. The first notch 450 may include a primary first notch 452, a secondary first notch 454, a tertiary first notch 456, and a quaternary first notch 458. The mount portion 436 may include at least one finger defined between adjacent notches. The finger may be configured to limit a movement of the mount portion 436 relative to the slot 480. The mount portion 436 may include a first finger 442 defined between the primary first notch 452 and the secondary first notch 454, the first finger 442 configured to limit the movement of the mount portion 436 relative to the slot 480. The mount portion 436 may include a second finger 444 defined between the secondary first notch 454 and the tertiary first notch 456, the second finger 444 configured to limit the movement of the mount portion 436 relative to the slot 480. The mount portion 436 may include a third finger 464 defined between tertiary first notch 456 and the quaternary first notch 458, the third finger 446 configured to limit the movement of the mount portion 436 relative to the slot 480. The mount portion 436 may include the slot 480 defined through the mount portion 436 and configured to receive the tail portion 410 therethrough to form a loop around a portion of the object (e.g., object 290) to attach the label 400. In aspects, the slot 480 is keyhole shaped and the width of the label 400 is greater than the length of the slot 480. The slot 480 defines the sidewall 482 that is configured for receipt into the at least one notch 450 of the loop portion when the label 400 is inserted through the slot 480 to restrain the label 400 in the slot 480. In this way, when the label 400 is inserted through the slot 480, the notch 450 and sidewall 482 restrain the label 400 in the slot 480. In implementations, the marking label 400 has a slot. In implementations, a slot may be omitted. In aspects, the label 400 may include a first label member, second label member, and folding portion, as described with respect to FIGS. 3A-3C above.

Referring now to FIG. 5, a fifth marking label 500 (label 500) that is configured to provide for the manipulation of an object (e.g., object 290) by a tool (e.g., tool 292) is illustrated. The fifth marking label 500 is similar to the second marking label 200 illustrated in FIG. 2 and the third marking label 300 illustrated in FIGS. 3A-3C and described above, except as detailed below. Thus, the marking label 500 includes a tail portion 510, a tool hole 514, a first indicia portion 518, a first side edge 526, a second side edge 528, a mount portion 536, a first notch 550, finger 542, finger 544, finger 562, finger 564, a second notch 570, a slot 580, a first sidewall 582, a second sidewall 584, and a strap hole 586. Unlike the label 300, which includes a first label member, a second label member, and a folding portion, the label 500 includes a single label member.

FIGS. 6A-6F are sequential illustrations of an example installation of the marking label 200 of FIG. 2 on the object 290 (e.g., cable). As a result, FIGS. 6A-6F can also be described as illustrating a method of applying a label to an object. The operations illustrated in FIGS. 6A-6F are not necessarily limited to the order or combinations shown for performing the operations. Further, one or more of the operations may be repeated, combined, reorganized, reordered, or linked to provide a wide array of additional and/or alternate methods. In portions of the following discussion, reference may be made to the example marking labels of FIG. 2 or to entities or processes as detailed in other figures (e.g., FIGS. 1 and 3-5), reference to which is made for example only.

In FIG. 6A, the technician places the cable 290 near the strap hole 286 and pulls the tail portion 210 towards the slot 280. In FIG. 6B, after inserting the end of the tail portion 210 into the slot 280, the technician slides the tail portion 210 through the slot 280. In FIG. 6C, the technician continues to pull the tail portion 210 until the fingers (e.g., finger 242, finger 244) and/or notches (e.g., first notch 250, second notch 252) engage the sidewall (e.g., first sidewall 282, second sidewall 284) of the slot 280, as illustrated in FIG. 6D. In FIG. 6E, the technician inserts the tail 298 of the cable tie 294 through the strap hole 286, around the cable 290, and back out the slot 280. The technician then inserts the tail 298 of the cable tie 294 into the head 296 and cinches the cable tie 294 down, as illustrated in FIG. 6F. In the aspect illustrated in FIG. 6F, a portion of the tail 298 of the cable tie 294 has been cut off.

As used herein, the term “object” is used to refer to all types and forms of objects, including but not limited to cables, electrical cables, conductors, wires, wire harnesses, hydraulic lines, pneumatic lines, hoses, optical fiber, textiles, plastics, pipes, tubing, conduits, and bundles of one or more of the same. An object may be elongated. While a cable is frequently used as an example object in this description and the Drawings, other types of objects may be substituted. The term “integral” is used in this disclosure to describe elements that are formed in one piece (a single, unitary piece) and cannot be separably removed from each other without causing permanent structural damage to the piece. Unless context dictates otherwise, the use of the terms slot, hole, aperture, and the like are interchangeable.

The components of the disclosed marking labels may be fabricated of any suitable material, including, but not limited to, a polymer (e.g., a polymeric material). Suitable polymeric materials may include one or more of polyamide (PA), polypropylene (PP), polyethylene (PE), polyphenylene sulfide (PPS), polyether ether ketone (PEEK), polyaryletherketone (PAEK), ethylene tetrafluoroethylene (ETFE), polyacetal (POM), polybutylene terephthalate (PBT), ultraviolet stabilized polyacetal (POMUV), polyester (PET), polyvinyl chloride (PVC), acrylonitrile styrene acrylate (ASA), cross-linked thermoplastics, partially cross-linked thermoplastics, higher-temperature resins, ultraviolet (UV) resistant resins, other thermoplastic materials, and the like, and copolymers, blends, or alloys thereof, as well as fiber-reinforced materials. A suitable polymeric material may include one or more additives (e.g., heat stabilizers (e.g., copper iodide), impact modifiers (e.g., polyolefin, urethane, rubber), UV stabilizers (e.g., carbon black, hindered amine light stabilizers (HALS)), flame retardants (e.g., nitrogen-based halogen-free flame retardants, melamine cyanurate, melamine borate, ammonium polyphosphate), colorants, and the like).

Some additional examples of marking labels are described in the following Examples.
Example 1. A comprising: a tool hole defined in the label and sized to receive a tool configured to manipulate an object by the label; and a mount portion configured to attach to the object, the mount portion configured to orient the label relative to the object to position the tool hole in a location spaced apart from the object.
Example 2. The label of Example 1, wherein the mount portion is configured to loop around the object to attach the label to the object.
Example 3. The label of Example 1, wherein the tool hole is defined through a tail portion of the label and the mount portion is integral to the tail portion.
Example 4. The label of Example 3, wherein the mount portion further comprises: at least one notch in a first side edge of the mount portion; and a slot defined through the mount portion and configured to receive the tail portion therethrough to form a loop around a portion of the object to attach the label to the object, the slot defining a sidewall, the sidewall configured for receipt into the at least one notch when the label is inserted through the slot to restrain the label in the slot.
Example 5. The label of Example 4, wherein the at least one notch comprises a first notch and the sidewall comprises a first sidewall, the label further comprises at least one second notch in a second side edge of the mount portion, the second side edge opposite the first side edge, the second notch opposite the first notch, and the slot further defines a second sidewall, the second sidewall opposite the first sidewall and configured for receipt into the second notch when the label is inserted through the slot to restrain the label in the slot.
Example 6. The label of Example 5, wherein the first notch further comprises a plurality of first notches and the second notch comprises a plurality of second notches.
Example 7. The label of Example 6, wherein the label is elongated and the first notches and the second notches extend generally perpendicular to a length of the label.
Example 8. The label of Example 6, wherein: the first notches and the second notches are aligned in pairs, an aligned first pair of the first and second notches is configured for receipt into the slot to respectively engage the first sidewall and the second sidewall to define a first diameter loop around the portion of the object, and an aligned second pair of the first and second notches is configured for receipt into the slot to respectively engage the first sidewall and the second sidewall to define a second diameter loop around the portion of the object, the first diameter loop smaller than the second diameter loop.
Example 9. The label of Example 5, wherein: the at least one notch further comprises a primary first notch, a secondary first notch, and a tertiary first notch, and the at least one second notch further comprises a primary second notch, a secondary second notch, and a tertiary second notch.
Example 10. The label of Example 9, wherein the mount portion further comprises: a first finger defined between the primary first notch and the secondary first notch, the first finger configured to limit a movement of the mount portion relative to the slot; a second finger defined between the primary second notch and the secondary second notch, the second finger configured to limit the movement of the mount portion relative to the slot; a third finger defined between the secondary first notch and the tertiary first notch, the third finger configured to limit the movement of the mount portion relative to the slot; and a fourth finger defined between the secondary second notch and the tertiary second notch, the fourth finger configured to limit the movement of the mount portion relative to the slot.
Example 11. The label of Example 3, wherein: the mount portion further comprises: a first mount portion; and a second mount portion; and the tail portion further comprises: a first label member comprising: a first tail portion configured to receive indicia; and the first mount portion; and a second label member comprising: a second tail portion configured to receive indicia; and the second mount portion.
Example 12. The label of Example 11, wherein the label further comprises: a folding portion that foldably connects the first label member and the second label member.
Example 13. The label of Example 1, further comprising: at least one adhesive portion on a first side of the label.
Example 14. The label of Example 13, wherein: the tool hole is defined through a tail portion of the label, the mount portion is integral to the tail portion, the mount portion further comprises: a first mount portion; and a second mount portion; and the tail portion further comprises: a first label member comprising: a first tail portion configured to receive indicia; and the first mount portion; a second label member comprising: a second tail portion configured to receive indicia; and the second mount portion.
Example 15. The label of Example 14, wherein the label further comprises a folding portion that foldably connects the first label member and the second label member.
Example 16. The label of Example 15, wherein the first label member is configured to fold over the second label member at the folding portion to adhere the first label member to the second label member via the at least one adhesive portion.
Example 17. The label of Example 1, wherein the mount portion further comprises: at least one strap hole defined through the mount portion and configured to receive a strap therethrough to cinch the mount portion to the object to orient the label in an angular position relative to the object to present the label with the tool hole positioned in the location spaced apart from the object.
Example 18. The label of Example 17, wherein the mount portion further comprises: a slot defined through the mount portion and configured to receive a tail portion of the label therethrough to form a loop around a portion of the object to attach the label to the object, and the strap hole and the slot are configured to receive a tail of the strap therethrough.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

In this description of aspects of marking labels, ordinal numbers such as “first” and “second” are used only to distinguish between different described objects and have no limitation on a location, a sequence, a priority, a quantity, content, or the like of the described objects. For example, a “first notch” is used as an example, and there may be one or more “notches.” Additionally, objects modified by different ordinal numbers may be the same or different objects. For example, if the described object is a “notch,” a “first notch” and a “second notch” may be the same or different notches.

In aspects, the techniques and apparatuses for marking labels may include one or more of the features of the marking labels illustrated in the Drawings and described in this Disclosure. Although implementations for marking labels have been described in language specific to certain features and/or methods, the subject of the appended claims is not necessarily limited to the specific features or methods described. Rather, the specific features and methods are disclosed as example implementations of marking labels.

What is claimed is:

1. A label comprising:
a tool hole defined in the label and sized to receive a tool configured to manipulate an object by the label; and
a mount portion configured to attach to the object, the mount portion configured to orient the label relative to the object to position the tool hole in a location spaced apart from the object.

2. The label of claim 1, wherein the mount portion is configured to loop around the object to attach the label to the object.

3. The label of claim 1, wherein the tool hole is defined through a tail portion of the label and the mount portion is integral to the tail portion.

4. The label of claim 3, wherein the mount portion further comprises:
at least one notch in a first side edge of the mount portion; and
a slot defined through the mount portion and configured to receive the tail portion therethrough to form a loop around a portion of the object to attach the label to the object, the slot defining a sidewall, the sidewall configured for receipt into the at least one notch when the label is inserted through the slot to restrain the label in the slot.

5. The label of claim 4, wherein the at least one notch comprises a first notch and the sidewall comprises a first sidewall, the label further comprises at least one second notch in a second side edge of the mount portion, the second side edge opposite the first side edge, the second notch opposite the first notch, and the slot further defines a second sidewall, the second sidewall opposite the first sidewall and configured for receipt into the second notch when the label is inserted through the slot to restrain the label in the slot.

6. The label of claim 5, wherein the first notch further comprises a plurality of first notches and the second notch comprises a plurality of second notches.

7. The label of claim 6, wherein the label is elongated and the first notches and the second notches extend generally perpendicular to a length of the label.

8. The label of claim 6, wherein:
the first notches and the second notches are aligned in pairs,
an aligned first pair of the first and second notches is configured for receipt into the slot to respectively engage the first sidewall and the second sidewall to define a first diameter loop around the portion of the object, and
an aligned second pair of the first and second notches is configured for receipt into the slot to respectively engage the first sidewall and the second sidewall to define a second diameter loop around the portion of the object, the first diameter loop smaller than the second diameter loop.

9. The label of claim 5, wherein:
the at least one notch further comprises a primary first notch, a secondary first notch, and a tertiary first notch, and
the at least one second notch further comprises a primary second notch, a secondary second notch, and a tertiary second notch.

10. The label of claim 9, wherein the mount portion further comprises:
a first finger defined between the primary first notch and the secondary first notch, the first finger configured to limit a movement of the mount portion relative to the slot;
a second finger defined between the primary second notch and the secondary second notch, the second finger configured to limit the movement of the mount portion relative to the slot;
a third finger defined between the secondary first notch and the tertiary first notch, the third finger configured to limit the movement of the mount portion relative to the slot; and
a fourth finger defined between the secondary second notch and the tertiary second notch, the fourth finger configured to limit the movement of the mount portion relative to the slot.

11. The label of claim 3, wherein:
the mount portion further comprises:
a first mount portion; and
a second mount portion; and
the tail portion further comprises:
a first label member comprising:
a first tail portion configured to receive indicia; and
the first mount portion; and
a second label member comprising:
a second tail portion configured to receive indicia; and
the second mount portion.

12. The label of claim 11, wherein the label further comprises:
a folding portion that foldably connects the first label member and the second label member.

13. The label of claim 1, further comprising:
at least one adhesive portion on a first side of the label.

14. The label of claim 13, wherein:
the tool hole is defined through a tail portion of the label,
the mount portion is integral to the tail portion,
the mount portion further comprises:
a first mount portion; and
a second mount portion; and
the tail portion further comprises:
a first label member comprising:
a first tail portion configured to receive indicia; and
the first mount portion;
a second label member comprising:
a second tail portion configured to receive indicia; and
the second mount portion.

15. The label of claim 14, wherein the label further comprises a folding portion that foldably connects the first label member and the second label member.

16. The label of claim 15, wherein the first label member is configured to fold over the second label member at the folding portion to adhere the first label member to the second label member via the at least one adhesive portion.

17. The label of claim 1, wherein the mount portion further comprises:
at least one strap hole defined through the mount portion and configured to receive a strap therethrough to cinch the mount portion to the object to orient the label in an angular position relative to the object to present the label with the tool hole positioned in the location spaced apart from the object.

18. The label of claim 17, wherein the mount portion further comprises:
a slot defined through the mount portion and configured to receive a tail portion of the label therethrough to form a loop around a portion of the object to attach the label to the object, and
the strap hole and the slot are configured to receive a tail of the strap therethrough.
